(19) United States
(12) Patent Application Publication
(10) Pub. No.: US 2024/0121062 A1
(43) Pub. Date: Apr. 11, 2024

(54) Method And Apparatus For Physical Uplink Control Channel (PUCCH) Carrier Switching In Mobile Communications

(71) Applicant: MediaTek Singapore Pte. Ltd., Singapore (SG)

(72) Inventors: Abdellatif Salah, Cambridge (GB); Mohammed S Aleabe Al-Imari, Cambridge (GB)

(21) Appl. No.: 18/284,852

(22) PCT Filed: May 6, 2022
(86) PCT No.: PCT/CN2022/091148

§ 371 Date: Sep. 28, 2023

Related U.S. Application Data
(60) Provisional application No. 63/185,386, filed on May 7, 2021.

(51) Int. Cl. H04L 5/00; H04L 1/1867; H04L 27/26

(52) U.S. Cl. CPC H04L 5/0053; H04L 1/1896; H04L 27/26025

(57) ABSTRACT

Various solutions for physical uplink control channel (PUCCH) carrier switching for hybrid automatic repeat request (HARQ) feedback with respect to user equipment (UE) and network apparatus in mobile communications are described. An apparatus, such as a UE, may receive a physical downlink control channel (PDCCH) on a first component carrier (CC). The apparatus may receive a physical downlink shared channel (PDSCH) on the first CC scheduled by the PDCCH. The apparatus may determine a second CC to transmit a physical uplink control channel (PUCCH) according to a configuration for PUCCH carrier switching. The apparatus may determine a slot offset subsequent to the PDSCH reception according to a first numerology of the first CC or a second numerology of the second CC. The apparatus may transmit the PUCCH corresponding to the PDSCH on the second CC according to the slot offset.

### CROSS REFERENCE TO RELATED PATENT APPLICATION(S)

The present disclosure is part of U.S. National Stage filing of International Patent Application No. PCT/CN2022/091148, filed 6 May 2022, which claims the priority benefit of U.S. Provisional Patent Application No. 63/185,386, filed on 7 May 2021. The contents of aforementioned application are herein incorporated by reference in their entirety.

### TECHNICAL FIELD

The present disclosure is generally related to mobile communications and, more particularly, to physical uplink control channel (PUCCH) carrier switching for hybrid automatic repeat request (HARQ) feedback with respect to user equipment (UE) and network apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR), hybrid automatic repeat request-acknowledgement (HARQ-ACK) information transmission is introduced to improve transmission reliability and robustness. The user equipment (UE) needs to report HARQ-ACK information for corresponding downlink receptions in a HARQ-ACK codebook. The HARQ-ACK codebook should be transmitted in a slot indicated by a value of a HARQ feedback timing indicator field in a corresponding downlink control information (DCI) format. The DCI format should also indicate the physical uplink control channel (PUCCH) resource scheduled for the HARQ-ACK information transmission. HARQ-ACK multiplexing can be used to facilitate HARQ-ACK information transmission. Multiple HARQ-ACK feedbacks corresponding to multiple physical downlink shared channel (PDSCH) transmissions may be accumulated, multiplexed and transmitted to the network apparatus at once. One PUCCH resource may be used to carry multiple HARQ-ACK feedbacks to be transmitted in the same slot.

The current framework of transmission of HARQ feedback bits is not suitable for URLLC. URLLC is introduced for emerging applications that demands high requirements on end-to-end latency and reliability. A general URLLC requirement is that a packet of size 32 bytes shall be transmitted within 1 millisecond end-to-end latency with a success probability of 10-5. URLLC traffic is typically sporadic and short whereas low-latency and high-reliability requirements are stringent. For example, the control reliability of URLLC has to be stricter than the data reliability which is up to 10-6 BLER. Accordingly, allowing only one PUCCH resource for HARQ feedback bits transmission in an uplink slot will add to transmission latency.

On the other hand, multi-link operation is introduced to increase system capacity and transmission efficiency of the communication systems. Multi-link operation can be implemented by carrier aggregation (CA) or dual connectivity (DC), where additional links are used to increase the amount of data that can be transferred to and from the UE. The UE can be configured with more than one radio links (e.g., component carriers) and can connect to more than one network nodes (e.g., serving cells). Under the framework of CA, cross-carrier scheduling is supported to improve transmission efficiency and reduce latency. Cross-carrier scheduling enables the UE to connect to different network nodes for receiving the downlink data on different carriers. Cross-carrier scheduling may also be used to balance the loads from traffic and scheduling across different component carriers. Without cross-carrier scheduling, the downlink scheduling assignments on physical downlink control channel (PDCCH) are only valid for the component carrier (CC) on which they were transmitted. With cross-carrier scheduling, the downlink scheduling assignments can be received on a CC other than the one on which PDCCH is received.

However, in current NR framework, cross-carrier scheduling for uplink control information (UCI) transmission (e.g., PUCCH) is not supported. In 3rd Generation Partnership Project (3GPP) Release-16, PUCCH carrier is semi-statically configured to a single cell within a PUCCH cell group. In a time division duplex (TDD) system, the uplink/downlink TDD pattern is the bottleneck for the URLLC latency. TDD allows uplink and downlink to use the entire frequency spectrum, but in different time slots. Time is divided up into short slots and some are designated for uplink while others are designated for downlink. This approach enables asymmetric traffic and time-varying uplink and downlink demands. However, since PUCCH can only be scheduled in uplink slots, in an event that TDD pattern allocates more slots as downlink slots, the duration between uplink slots will be drawn too long and cause long latency. The worst case PUCCH alignment delay is dominated by the length of downlink and uplink and may be prohibitive to apply URLLC retransmission. Therefore, there is a need to introduce cross-carrier scheduling on PUCCH transmission and enhance UCI transmission for URLLC.

Accordingly, how to reduce alignment delay/latency and enhance reliability is an important issue for URLLC applications in the newly developed wireless communication network. Therefore, there is a need to provide proper cross-carrier scheduling mechanisms and UCI transmission enhancement for better performance when URLLC is supported.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to PUCCH carrier switching for HARQ feedback with respect to user equipment and network apparatus in mobile communications.

In one aspect, a method may involve an apparatus receiving a PDCCH on a first CC. The method may also involve the apparatus receiving a PDSCH on the first CC scheduled by the PDCCH. The method may further involve the apparatus determining a second CC to transmit a PUCCH according to a configuration for PUCCH carrier switching. The method may further involve the apparatus determining a slot offset subsequent to the PDSCH reception according to a first numerology of the first CC or a second numerology of the second CC. The method may further involve the apparatus transmitting the PUCCH corresponding to the PDSCH on the second CC according to the slot offset.

In another aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a PDCCH on a first CC. The processor may also perform operations comprising receiving, via the transceiver, a PDSCH on the first CC scheduled by the PDCCH. The processor may further perform operations comprising determining a second CC to transmit a PUCCH according to a configuration for PUCCH carrier switching. The processor may further perform operations comprising determining a slot offset subsequent to the PDSCH reception according to a first numerology of the first CC or a second numerology of the second CC. The processor may further perform operations comprising transmitting, via the transceiver, the PUCCH corresponding to the PDSCH on the second CC according to the slot offset.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a block diagram of an example communication system in accordance with an implementation of the present disclosure.

FIG. 3 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to dynamic cross-carrier scheduling for latency enhancement with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In current NR framework, cross-carrier scheduling for UCI transmission (e.g., PUCCH) is not supported. In 3GPP Release-16, PUCCH carrier is semi-statically configured to a single cell within a PUCCH cell group. In a TDD system, the uplink/downlink TDD pattern is the bottleneck for the URLLC latency. TDD allows uplink and downlink to use the entire frequency spectrum, but in different time slots. Time is divided up into short slots and some are designated for uplink while others are designated for downlink. This approach enables asymmetric traffic and time-varying uplink and downlink demands. However, since PUCCH can only be scheduled in uplink slots, in an event that TDD pattern allocate more slots as downlink slots, the duration between uplink slots will be drawn too long and cause long latency. The worst case PUCCH alignment delay is dominated by the length of downlink and uplink and may be prohibitive to apply URLLC retransmission. Therefore, there is a need to introduce cross-carrier scheduling on PUCCH transmission and enhance UCI transmission for URLLC.

In view of the above, the present disclosure proposes a number of schemes pertaining to PUCCH carrier switching for HARQ feedback with respect to the UE and network apparatus in mobile communications. According to the schemes of the present disclosure, a CA system of TDD carriers with an appropriate slot offset between uplink slots on different CC's is supported. The UE can be configured with dynamic cross-carrier scheduling for PUCCH. Dynamic switching of CC used for PUCCH (referred to herein as PUCCH carrier switching) can help to reduce the latency for CA with two or multiple carriers having different TDD patterns. The time domain pattern configurations for PUCCH carrier switching are based on the numerology of the reference cell, wherein the time domain pattern is also referred to as the PUCCH carrier pattern which may configure a primary cell (PCell) and a secondary cell (SCell) within the PUCCH cell group that can be used to transmit the PUCCH, and the reference cell may refer to the PCell, PSCell, or PUCCH-SCell. More specifically, the PDSCH to HARQ-ACK offset K1 (i.e., the slot offset between the DL slot where the data is scheduled on the PDSCH and the UL slot where the HARQ-ACK feedback for the scheduled PDSCH data needs to be transmitted) is interpreted based on the numerology and/or the PUCCH configuration of the reference cell, such that the UE may be able to apply PUCCH carrier switching. In addition, the PUCCH carrier switching may be enabled by a radio resource control (RRC) configuration, and/or may be enabled per PUCCH cell group. Furthermore, a new downlink control information (DCI) bit-field (e.g., called ‘PUCCH carrier switching’ bit-field) may be introduced in the DCI format 1_1 or 1_2 to signal the target PUCCH carrier, and the presence of the bit-field in the DCI format 1_1 or 1_2 may be RRC configured to the UE (i.e., configured by RRC signaling). Accordingly, by applying the schemes of the present disclosure, the performance of HARQ feedback transmission can be improved to reduce alignment delay/latency. Applications with URLLC requirements can benefit from the enhancements achieved by the implementations of the present disclosure.

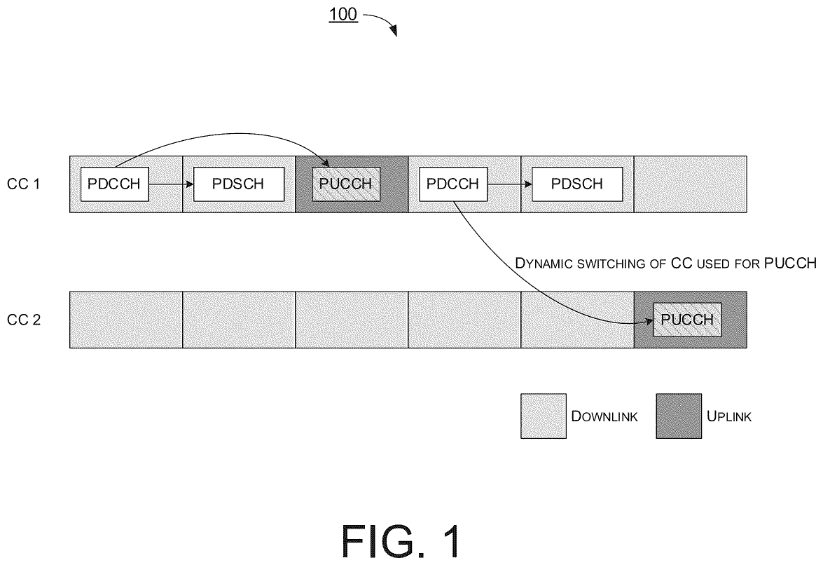

FIG. 1 illustrates an example scenario 100 under schemes in accordance with implementations of the present disclosure. Scenario 100 involves a UE and a plurality of network nodes, which may be a part of a wireless communication network (e.g., an LTE network, a 5G network, an NR network, an IoT network or an NB-IoT network). Scenario 100 illustrates an example of dynamic cross-carrier scheduling for PUCCH. The UE may be configured with a plurality of CCs such as a first CC (e.g., CC 1) and a second CC (e.g., CC 2). The first CC and the second CC may have different TDD patterns for uplink/downlink slots. For example, the ratio of downlink slot to uplink slot is 3:1 for CC 1 and 5:1 for CC 2. To reduce the alignment delay, the UE may be configured with PUCCH carrier switching.

Specifically, the UE may receive a PDCCH on the first CC. The PDCCH may schedule a PDSCH on the first CC. The UE may receive the PDSCH on the first CC scheduled by the PDCCH. Then, the UE needs to transmit the HARQ-ACK information corresponding to the PDSCH to the network node. Therefore, the PDCCH may further schedule a PUCCH for transmitting the HARQ-ACK information. To reduce latency, the PUCCH may be scheduled on a different CC. For example, the closest uplink slot for PUCCH transmission is allocated on the second CC. Thus, the UE may determine the second CC to transmit the PUCCH according to a configuration for PUCCH carrier switching. Then, the UE may transmit the PUCCH corresponding to the PDSCH on the second CC scheduled by the PDCCH.

In some implementations, the length of the PUCCH carrier pattern may be variable from 1 to maximum number of the slots in a frame. Specifically, slot length gets different depending on numerology, and numerology indicates subcarrier spacing type. For normal cyclic prefix (CP) and slot configuration 0, if numerology is 0, the corresponding subcarrier spacing is 15 kHz, and the slot length is 1 ms. If numerology is 1, the corresponding subcarrier spacing is 30 kHz, and the slot length is 0.5 ms. If numerology is 2, the corresponding subcarrier spacing is 60 kHz, and the slot length is 0.25 ms. If numerology is 3, the corresponding subcarrier spacing is 120 kHz, and the slot length is 0.125 ms. If numerology is 4, the corresponding subcarrier spacing is 240 kHz, and the slot length is 0.0625 ms. Therefore, slot length gets shorter as subcarrier spacing gets wider. Thus, minimum length (i.e., one slot) of the PUCCH carrier pattern may get shorter as subcarrier spacing gets wider, and maximum length (i.e., one frame) of the PUCCH carrier pattern may be the same at different subcarrier spacing.

In some implementations, the first CC and the second CC may be configured with different numerologies or different slot/sub-slot partitioning configurations. In an event that the numerology or slot/sub-slot partitioning configuration of the first CC for receiving PDCCH and downlink data is different from the numerology or slot/sub-slot partitioning configuration of the second CC for transmitting PUCCH, slot offsets (e.g., the PDSCH to HARQ-ACK offset K1) in the scheduling assignment, for example, which slot the assignment relates to, are interpreted based on the numerology and/or slot/sub-slot partitioning configuration of the first CC or the second CC.

Some methods are provided for configuring dynamically selectable multiple choices of CC to use for PUCCH carrying HARQ-ACK information. For example, within a cell group, the CC to use for PUCCH should be dynamically selectable. The configuration for PUCCH carrier switching may comprise a plurality of CCs configured to be used to transmit the PUCCH. Some restrictions on the number of selectable CC could apply. For example, only a pre-determined number of CCs (e.g., K=2 CCs) could be used to transmit the PUCCH. The UE may receive a configuration (e.g., radio resource control (RRC) configuration) configuring a plurality of CCs within a cell group that can be used to transmit the PUCCH. For example, appointing multiple serving cells within cell group to use for PUCCH may be supported (e.g., per PDSCH-ServingCell configuration). PUCCH-Cell field of PDSCH-ServingCellConfig should be allowed to list at most K elements of ServCelllndex. The content of the HARQ-ACK codebook carried by the PUCCH is independent from the CC selected for PUCCH transmission (e.g., CC 2).

The configuration for PUCCH carrier switching may comprise a physical layer signaling. In one example, the configuration may comprise a data field used to select a CC from a plurality of different CCs to transmit the PUCCH. A new data field may be introduced for explicit selection of the target PUCCH carrier among K different CCs. In one example, the earliest uplink slot/sub-slot on any CC may be selected. This behaviour may be configured with a HARQ procedure, or signalled by a special K1 index/value, or any other affordable way to signal 1 bit. In a further example, the configuration may comprise a data field used to select a CC and a slot/sub-slot. The CC and slot/sub-slot may be selected by the same field K1 which counts the slot/sub-slot boundaries across all CCs that can be selected for PUCCH transmission. Optionally, the slot/sub-slot count can be increased in an event that the slot/sub-slot following the boundary contains uplink symbols or flexible downlink/uplink symbols. The reference point for K1 offset can be the end of PDSCH reception or the end of N1 UE processing timeline.

In some implementations, the configuration for PUCCH carrier switching may be received in the downlink control information (DCI) format 1_1 or 1_2 which comprises a new data field used to indicate the CC to transmit PUCCH, and the presence of the new data field may be RRC configured to the UE.

In some implementations, the support of PUCCH carrier switching may be defined as a UE capability. The UE may be configured to report to the network node in an event that it can support PUCCH carrier switching. The UE may report the number or the maximum number of groups (e.g., PUCCH groups, cell-groups, or newly defined groups of cells) on which it can support dynamic cross-carrier scheduling for PUCCH. The UE may also report its capability for each group (e.g., a PUCCH group, a cell-group, or a newly defined group of cells) in an event that it can support PUCCH carrier switching. In another example, the UE may report the number of PUCCH groups on which it can support dynamic cross-carrier scheduling. In another example, the UE may report the number of PUCCH groups on which it can support semi-static cross-carrier scheduling and/or dynamic cross-carrier scheduling. In another example, a specified number of CCs for dynamic cross-carrier scheduling may be defined and the UE may report which number it can support. Furthermore, the UE may report for each group (e.g., a PUCCH group, a cell-group, or a newly defined group of cells) the number N of carriers on which it can support PUCCH carrier switching. The UE may report for each carrier if it can support PUCCH carrier switching. The UE may report the total number or the maximum number of carriers on which it can support PUCCH carrier switching.

In some implementations, joint operation of PUCCH carrier switching and semi-persistent scheduling (SPS) HARQ-ACK deferral may be supported to avoid dropping of SPS HARQ-ACK when overlapping with DL slots in TDD. In other words, the SPS HARQ-ACK transmission may be deferred and transmitted on a different PUCCH carrier (i.e., a carrier that is different from the carrier on which the corresponding PDSCH is received). Semi-static rules may be defined for SPS HARQ-ACK deferral to the earliest available PUCCH carrier. In one example, a cell index (e.g., the smallest index or largest index) is used to select the target PUCCH carrier. In another example, transmission on PCell is prioritized. A PUCCH carrier pattern may be defined for SPS HARQ-ACK deferral. In one example, the PUCCH carrier pattern may have slot granularity, sub-slot granularity, or symbol granularity. In one example, the PUCCH carrier pattern may be based on the granularity of the PCell. In another example, the PUCCH carrier pattern may be based on the granularity of the carrier with the largest numerology in the PUCCH cell group. The PUCCH carrier pattern may be RRC configured to the UE.

In some implementations, some restrictions may be applied on PUCCH carrier switching. For example, PUCCH carrier switching may be restricted to PUCCH carriers with the same numerology. Alternatively, PUCCH carrier switching between PUCCH carriers of different numerologies may be supported as a UE capability, and the UE may report its support of this capability to the gNB, such that the gNB RRC may configure PUCCH carrier switching for the UE with this capability. In another example, PUCCH carrier switching may be restricted to PUCCH carriers with the same sub-slot PUCCH duration. Alternatively, PUCCH carrier switching between PUCCH carriers of different sub-slot PUCCH durations may be supported as a UE capability, and the UE may report its support of this capability to the gNB, such that the gNB RRC may configure PUCCH carrier switching for the UE with this capability.

In some implementations, PUCCH carrier switching may be enabled/disabled for inter-band CA, intra-band CA, or CA with supplementary uplink (SUL). In one example, PUCCH carrier switching for inter-band CA, intra-band CA, or CA with SUL may be defined as a UE capability. In another example, PUCCH carrier switching for inter-band CA, intra-band CA, or CA with SUL may be RRC configured to the UE.

### Illustrative Implementations

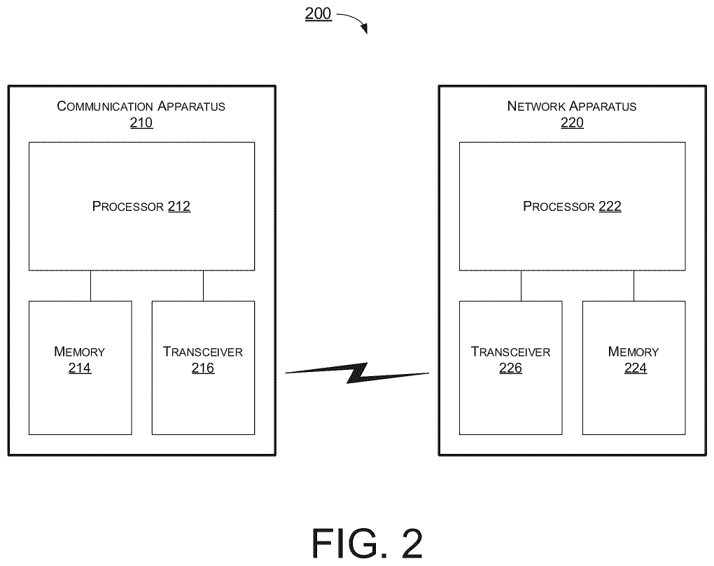

FIG. 2 illustrates an example communication system 200 having an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to PUCCH carrier switching for HARQ feedback with respect to user equipment and network apparatus in mobile communications, including scenarios/schemes described above as well as process 300 described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an IoT, NB-IoT, or lloT apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus, which may be a network node such as a base station, a small cell, a router or a gateway. For instance, network apparatus 220 may be implemented in an eNodeB in an LTE, LTE-Advanced or LTE-Advanced Pro network or in a gNB in a 5G, NR, IoT, NB-IoT or lloT network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including power consumption reduction in a device (e.g., as represented by communication apparatus 210) and a network (e.g., as represented by network apparatus 220) in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE and network apparatus 220 is implemented in or as a network node of a communication network.

In some implementations, processor 212 may receive, via transceiver 216, a PDCCH on the first CC. The PDCCH may schedule a PDSCH on the first CC. Processor 212 may receive, via transceiver 216, the PDSCH on the first CC scheduled by the PDCCH. Then, processor 212 needs to transmit the HARQ-ACK information corresponding to the PDSCH to the network node. Therefore, the PDCCH may further schedule a PUCCH for transmitting the HARQ-ACK information. To reduce latency, the PUCCH may be scheduled on a different CC. For example, the closest uplink slot for PUCCH transmission is allocated on the second CC. Thus, processor 212 may determine the second CC to transmit the PUCCH according to a configuration for PUCCH carrier switching. Processor 212 may further determine the slot offset subsequent to the PDSCH reception according to a first numerology of the first CC or a second numerology of the second CC. Then, processor 212 may transmit, via transceiver 216, the PUCCH corresponding to the PDSCH on the second CC according to the slot offset.

In some implementations, processor 212 may receive, via transceiver 216, a configuration (e.g., RRC configuration) configuring a plurality of CCs within a cell group that can be used to transmit the PUCCH. Processor 212 may receive the configuration for PUCCH carrier switching via a physical layer signaling (e.g., DCI format 1_1 or 1_2) which indicates the target CC (i.e., the second CC) to transmit the PUCCH.

In some implementations, processor 212 may be configured to defer the UCI transmission that includes HARQ-ACK information to be performed on another carrier in an event that the determined PUCCH slot on the target CC is not the target PUCCH slot specified in the SPS HARQ-ACK deferral rule.

### Illustrative Processes

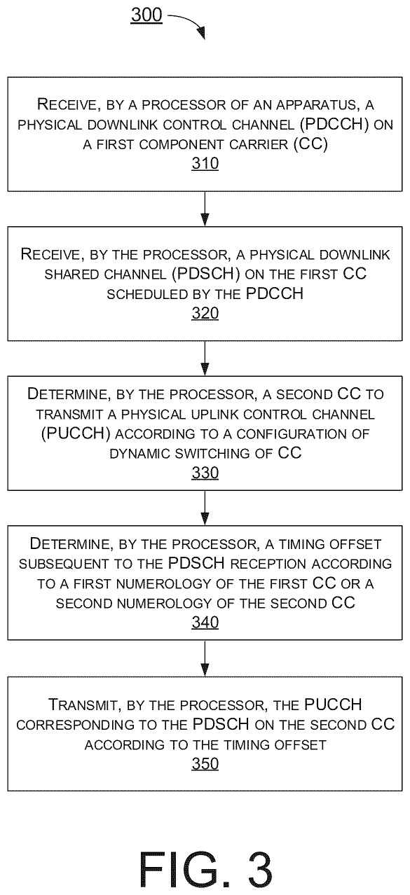

FIG. 3 illustrates an example process 300 in accordance with an implementation of the present disclosure. Process 300 may be an example implementation of schemes described above, whether partially or completely, with respect to dynamic cross-carrier scheduling for latency enhancement with the present disclosure. Process 300 may represent an aspect of implementation of features of communication apparatus 210. Process 300 may include one or more operations, actions, or functions as illustrated by one or more of blocks 310, 320, 330, 340, and 350. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices. Solely for illustrative purposes and without limitation, process 300 is described below in the context of communication apparatus 210. Process 300 may begin at block 310.

At 310, process 300 may involve processor 212 of apparatus 210 receiving a PDCCH on a first CC. Process 300 may proceed from 310 to 320.

At 320, process 300 may involve processor 212 receiving a PDSCH on the first CC scheduled by the PDCCH. Process 300 may proceed from 320 to 330.

At 330, process 300 may involve processor 212 determining a second CC to transmit a PUCCH according to a configuration for PUCCH carrier switching. Process 300 may proceed from 330 to 340.

At 340, process 300 may involve processor 212 determining a slot offset subsequent to the PDSCH reception according to a first numerology of the first CC or a second numerology of the second CC. Process 300 may proceed from 340 to 350.

At 350, process 300 may involve processor 212 transmitting the PUCCH corresponding to the PDSCH on the second CC according to the slot offset.

In some implementations, the slot offset is determined also according to a slot or sub-slot partitioning configuration of the first CC or the second CC.

In some implementations, the PUCCH carrier switching is enabled by an RRC configuration.

In some implementations, the PUCCH carrier switching is enabled per PUCCH cell group.

In some implementations, the configuration is received in a DCI format 1_1 or 1_2. The configuration may comprise a data field indicating the second CC to transmit the PUCCH, and the presence of the data field in the DCI format 1_1 or 1_2 is configured by RRC signaling.

In some implementations, process 300 may involve processor 212 deferring the transmitting to be performed on another carrier in an event that the transmitting comprises transmitting SPS HARQ-ACK.

In some implementations, the first CC and the second CC are configured with the same or different numerologies or configured with the same or different sub-slot PUCCH durations.

In some implementations, the PUCCH carrier switching is enabled or disabled for inter-band CA, intra-band CA, or CA with SUL.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a physical downlink control channel (PDCCH) on a first component carrier (CC);
receiving, by the processor, a physical downlink shared channel (PDSCH) on the first CC scheduled by the PDCCH;
determining, by the processor, a second CC to transmit a physical uplink control channel (PUCCH) according to a configuration for PUCCH carrier switching;
determining, by the processor, a slot offset subsequent to the PDSCH reception according to a first numerology of the first CC or a second numerology of the second CC; and
transmitting, by the processor, the PUCCH corresponding to the PDSCH on the second CC according to the slot offset.

2. The method of claim 1, wherein the slot offset is determined also according to a slot or sub-slot partitioning configuration of the first CC or the second CC.

3. The method of claim 1, wherein the PUCCH carrier switching is enabled by a radio resource control (RRC) configuration.

4. The method of claim 1, wherein the PUCCH carrier switching is enabled per PUCCH cell group.

5. The method of claim 1, wherein the configuration is received in a downlink control information (DCI) format 1_1 or 1_2.

6. The method of claim 5, wherein the configuration comprises a data field indicating the second CC to transmit the PUCCH.

7. The method of claim 6, wherein presence of the data field in the DCI format 1_1 or 1_2 is configured by RRC signaling.

8. The method of claim 1, wherein the transmitting comprises transmitting semi-persistent scheduling (SPS) hybrid automatic repeat request-acknowledgement (HARQ-ACK), and the method further comprises:
deferring the transmitting to be performed on another carrier.

9. The method of claim 1, wherein the first CC and the second CC are configured with the same or different numerologies, or configured with the same or different sub-slot PUCCH durations.

10. The method of claim 1, wherein the PUCCH carrier switching is enabled or disabled for inter-band carrier aggregation (CA), intra-band CA, or CA with supplementary uplink (SUL).

11. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a physical downlink control channel (PDCCH) on a first component carrier (CC);
receiving, via the transceiver, a physical downlink shared channel (PDSCH) on the first CC scheduled by the PDCCH;
determining a second CC to transmit a physical uplink control channel (PUCCH) according to a configuration for PUCCH carrier switching;
determining a slot offset subsequent to the PDSCH reception according to a first numerology of the first CC or a second numerology of the second CC; and
transmitting, via the transceiver, the PUCCH corresponding to the PDSCH on the second CC according to the slot offset.

12. The apparatus of claim 11, wherein the slot offset is determined also according to a slot or sub-slot partitioning configuration of the first CC or the second CC.

13. The apparatus of claim 11, wherein the PUCCH carrier switching is enabled by a radio resource control (RRC) configuration.

14. The apparatus of claim 11, wherein the PUCCH carrier switching is enabled per PUCCH cell group.

15. The apparatus of claim 11, wherein the configuration is received in a downlink control information (DCI) format 1_1 or 1_2.

16. The apparatus of claim 15, wherein the configuration comprises a data field indicating the second CC to transmit the PUCCH.

17. The apparatus of claim 16, wherein presence of the data field in the DCI format 1_1 or 1_2 is configured by RRC signaling.

18. The apparatus of claim 11, wherein the transmitting comprises transmitting semi-persistent scheduling (SPS) hybrid automatic repeat request-acknowledgement (HARQ-ACK), and wherein, during operation, the processor further performs operations comprising:
deferring the transmitting to be performed on another carrier.

19. The apparatus of claim 11, wherein the first CC and the second CC are configured with the same or different numerologies, or configured with the same or different sub-slot PUCCH durations.

20. The apparatus of claim 11, wherein the PUCCH carrier switching is enabled or disabled for inter-band carrier aggregation (CA), intra-band CA, or CA with supplementary uplink (SUL).
